(19) United States
(12) Patent Application Publication
(10) Pub. No.: US 2026/0133419 A1
(43) Pub. Date: May 14, 2026

(54) METHOD AND SYSTEM FOR HAND TRACKING FOR HEAD MOUNTED DISPLAY

(71) Applicant: Samsung Electronics Co., Ltd., Suwon-si (KR)

(72) Inventors: Janet MARY, Bangalore (IN); Green Rosh K S, Bengaluru (IN); Bindigan Hariprasanna PAWAN PRASAD, Bangalore (IN); Vishakha S R, Bengaluru (IN); Sanjay NARASIMHA MURTHY, Bangalore (IN); Ashok GEORGE, Chowara PO (IN)

(21) Appl. No.: 19/292,456

(22) Filed: Aug. 6, 2025

Related U.S. Application Data
(63) Continuation of application No. PCT/KR2025/005413, filed on Apr. 22, 2025.

(30) Foreign Application Priority Data
Nov. 11, 2024 (IN) 202441086826

(51) Int. Cl. G02B 27/00; G02B 27/01

(52) U.S. Cl. CPC G02B 27/0093; G02B 27/0172; G02B 2027/0138

(57) ABSTRACT

A method for hand tracking for a head mounted display comprises: obtaining one or more input images of one or more hands of a user and identifying at least one wearable accessory including a plurality of trackable portions; determining a plurality of feature points in the plurality of trackable portions and determining a first motion trajectory by tracking a plurality of key-points of the one or more hands and determining a second motion trajectory of the wearable accessory by tracking a plurality of feature points in the trackable portions of the wearable accessory and generating a hand-trajectory noise model by correlating the first motion trajectory with the second motion trajectory and performing hand tracking by correcting the first motion trajectory using the noise model.

### CROSS-REFERENCE TO RELATED APPLICATIONS

This application is a continuation of International Application No. PCT/KR2025/005413 designating the United States, filed on Apr. 22, 2025, in the Korean Intellectual Property Receiving Office and claiming priority to Indian Provisional Patent Application No. 202441086826, filed on Nov. 11, 2024, and to Indian Patent Application No. 202441086826, filed on Feb. 14, 2025, the disclosures of each of which are incorporated by reference herein in their entireties.

### BACKGROUND

### Field

The disclosure relates to the field of computer vision and human-computer interaction. For example, the disclosure relates to a method and system for hand tracking for head mounted display.

### Description of Related Art

The information in this section merely provides background information related to the present disclosure and may not constitute prior art(s) for the present disclosure.

Hand-tracking technology has become increasingly crucial in modern augmented reality (AR) and virtual reality (VR) systems, particularly in video see-through (VST) devices. This technology enables users to interact naturally with virtual environments without requiring physical controllers, thereby enhancing immersion and user experience. Accurate and responsive hand tracking serves as a fundamental interface between users and virtual content in various applications ranging from gaming to professional tools.

Conventional hand-tracking systems typically employ computer vision algorithms to detect and track hand movements in real-time. These systems generally work by identifying key anatomical landmarks on the hand and wrist, establishing a point of origin and related anatomical points for tracking for example, the wrist area, and continuously monitoring the spatial relationships between these points to reconstruct hand poses and movements. The accuracy and stability of this origin point are crucial for maintaining consistent hand tracking performance.

While existing hand-tracking solutions demonstrate considerable effectiveness under optimal conditions, they face significant challenges in maintaining stable tracking across diverse usage scenarios, especially when there is insufficient visual differentiation to indicate point of origin and relative keypoints. These challenges become particularly apparent during extended usage sessions with multiple applications, during gaming scenarios that involve rapid hand movements, in environments with varying lighting conditions, and when transitioning between different interaction modes.

A common challenge in current hand-tracking systems is the phenomenon of tracking instability, which manifests as jitter or sudden, unexpected movements in the virtual representation of the user's hands.

### SUMMARY

According to an example embodiment of the present disclosure, a method for hand tracking for a Head Mounted Display (HMD) device is disclosed. The method includes: obtaining one or more input images of one or more hands of a user and identifying at least one wearable accessory including a plurality of trackable portions, worn by the user on any one of the one or more hands; determining a plurality of feature points in the plurality of trackable portions of the at least one wearable accessory; determining a first motion trajectory of the one or more hands by tracking a plurality of key-points of the one or more hands of the user; determining a second motion trajectory of the wearable accessory by tracking a plurality of feature points in the trackable portions of the wearable accessory; generating a hand-trajectory noise model by correlating the first motion trajectory of the one or more hands of the user with the second motion trajectory of the wearable accessory; and performing hand tracking of the one or more hands of the user by correcting the corresponding first motion trajectory using the obtained hand-trajectory noise model.

According to an example embodiment, a system for hand tracking for a Head Mounted Display (HMD) device is disclosed. The system includes: a memory storing at least one instruction, and at least one processor, comprising a processing circuitry, wherein the at least one processor is configured to individually or collectively execute the at least one instruction stored in the memory to: obtain one or more input images of one or more hands of a user and identify at least one wearable accessory including a plurality of trackable portions, worn by the user on any one of the one or more hands; determine a plurality of feature points in the plurality of trackable portions of the at least one wearable accessory; determine a first motion trajectory of the one or more hands by tracking a plurality of key points of the one or more hands of the user; determine a second motion trajectory of the wearable accessory by tracking a plurality of feature points in the trackable portions of the wearable accessory; and generate a hand-trajectory noise model by correlating the first motion trajectory of the one or more hands of the user with the second motion trajectory of the wearable accessory; and perform hand tracking of the one or more hands of the user by correcting the corresponding first motion trajectory using the obtained hand-trajectory noise model.

To further clarify the advantages and features of the present disclosure, a more detailed description of the present disclosure will be rendered by reference to various example embodiments thereof, which are illustrated in the appended drawings. It is appreciated that these drawings depict example embodiments of the present disclosure and are therefore not to be considered limiting of its scope. The present disclosure will be described and explained with additional specificity and detail with the accompanying drawings.

### BRIEF DESCRIPTION OF THE DRAWINGS

These and other features, aspects, and advantages of certain embodiments of the present disclosure will be more apparent from the following detailed description, taken in conjunction with the accompanying drawings in which like characters represent like parts throughout the drawings, and in which:

FIG. 1A is a diagram illustrating a virtual representation of the user's hands showing instability in the VR system, according to the related art;

FIG. 1B is a diagram illustrating a virtual representation of the user's hands showing instability in the VR system, according to the related art;

FIG. 2 is a block diagram illustrating an example configuration of the system for hand tracking using a wearable accessory, according to various embodiments;

FIG. 3 is a flowchart illustrating example operations of hand tracking using the wearable accessory, according to various embodiments;

FIG. 4 is a flowchart illustrating example operations to identify the trackable portions of the wearable accessory, according to various embodiments;

FIG. 5 is a flowchart illustrating example operations for combining tracking points to obtain an accessory trajectory, according to various embodiments;

FIG. 6 is a flowchart illustrating example operations of generating a trajectory noise model, according to various embodiments; and

FIG. 7A is a flowchart illustrating an example method for hand tracking using a wearable accessory, according to various embodiments.

FIG. 7B is a flowchart illustrating an example method for hand tracking using a wearable accessory, according to various embodiments.

Further, skilled artisans will appreciate that elements in the drawings are illustrated for simplicity and may not have necessarily been drawn to scale.

Furthermore, in terms of the construction of the device, one or more components of the device may have been represented in the drawings by conventional symbols, and the drawings may show various details that are pertinent to understanding the various embodiments of the present disclosure so as not to obscure the drawings with details that will be readily apparent to those of ordinary skill in the art having the benefit of the description herein.

### DETAILED DESCRIPTION

For the purpose of aiding in an understanding of the present disclosure, reference will now be made to the various example embodiments and specific language will be used to describe the same. It will nevertheless be understood that no limitation of the scope of the present disclosure is thereby intended, such alterations and further modifications in the illustrated system, and such further applications of the principles of the present disclosure as illustrated therein being contemplated as would understood by one skilled in the art to which the present disclosure relates.

It will be understood by those skilled in the art that the foregoing general description and the following detailed description are explanatory of the present disclosure and are not intended to be restrictive thereof.

Whether or not a certain feature or element was limited to being used only once, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language including, but not limited to, “there needs to be one or more . . . ” or “one or more elements is required.”

Reference is made herein to various “embodiments.” It should be understood that an embodiment is an example of a possible implementation of any features and/or elements of the present disclosure. Various embodiments have been described for the purpose of explaining one or more of the potential ways in which the specific features and/or elements of the disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, in the context of more than one embodiment, or in the context of all embodiments, the features and/or elements may instead be provided separately or in any appropriate combination or not at all. Any features and/or elements described in the context of separate embodiments may alternatively be realized as existing together in the context of a single embodiment.

Any particular and all details set forth herein are used in the context of various example embodiments and therefore should not necessarily be taken as limiting factors to the disclosure.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Hereinafter, it is understood that terms including “unit” or “module” at the end may refer to a unit for processing at least one function or operation and may be implemented in hardware, software, or a combination of hardware and software.

Unless otherwise defined, all terms, and especially any technical and/or scientific terms, used herein may be taken to have the same meaning as commonly understood by one having ordinary skill in the art.

The various example embodiments herein and the various features and advantageous details thereof are explained more fully with reference to the non-limiting embodiments that are illustrated in the accompanying drawings and detailed in the following description. Descriptions of well-known components and processing techniques may be omitted to not unnecessarily obscure the description herein. The various example embodiments described herein are not necessarily mutually exclusive, as various embodiments can be combined with one or more other embodiments to form new embodiments. The term “or” as used herein, refers to a non-exclusive or unless otherwise indicated. The examples used herein are intended merely to facilitate an understanding of ways in which the various embodiments herein can be practiced and to further enable those skilled in the art to practice the disclosure. Accordingly, the examples should not be construed as limiting the scope of the disclosure herein.

Various embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits of a block may be implemented by dedicated hardware, by a processor (e.g., one or more programmed microprocessors and associated circuitry), or by a combination of dedicated hardware to perform some functions of the block and a processor to perform other functions of the block. Each block of the various embodiments may be physically separated into two or more interacting and discrete blocks without departing from the scope of the disclosure. Likewise, the blocks of the various embodiments may be physically combined into more complex blocks without departing from the scope of the disclosure.

It should be appreciated that the blocks in each flowchart and combinations of the flowcharts may be performed by one or more computer programs which include computer-executable instructions. The entirety of the one or more computer programs may be stored in a single memory or the one or more computer programs may be divided with different portions stored in different multiple memories.

The accompanying drawings are used to help easily understand various technical features and it should be understood that the various example embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

The present disclosure may provide smooth hand tracking for a head-mounted display (HMD).

The present disclosure may utilize a visually differentiated wearable accessory such as a watch or a wristband, to stabilize the hand movement thereby reducing jitter.

The present disclosure may estimate a hand trajectory noise to model using a correlation between the wearable accessory and hand trajectories.

The present disclosure may use the estimated noise model to remove jitter in hands on the head mounted display, without accessories as well.

The method and system of the present disclosure eliminates hand jitter during hand tracking, using hand accessories and wearables. The present disclosure uses wearable accessory tracking information to stabilize hand tracking of the accessory hand. For example, the present disclosure tracks points on the accessory to correct noise in the hand motion trajectory of the accessory hand. Furthermore, the present disclosure uses the noise model generated to correct noise in the hand tracking of the non-accessory hand.

Embodiments of the present disclosure will be described below in greater detail with reference to the accompanying drawings.

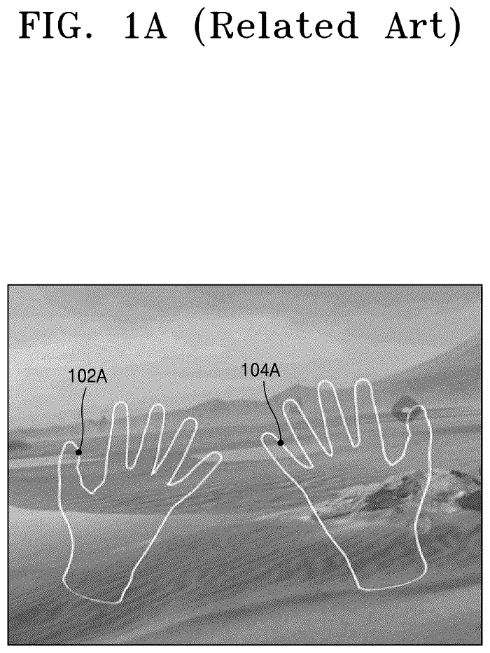

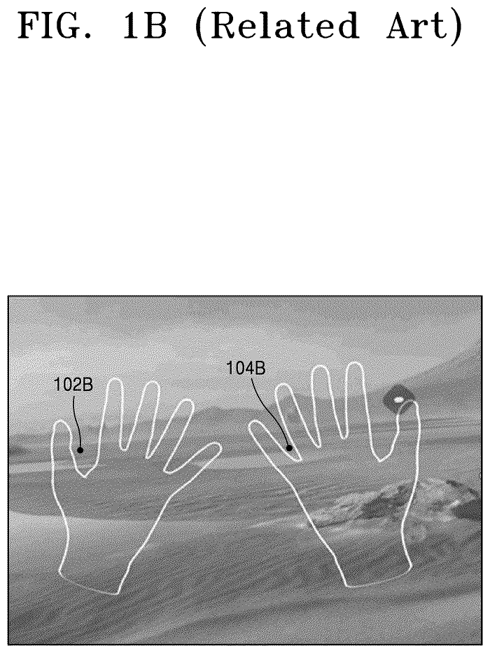

FIG. 1A illustrates the virtual representation of the user's hands showing instability in the VR system, according to the related art. FIG. 1B illustrates the virtual representation of the user's hands showing instability in the VR system, according to the related art.

As shown in FIGS. 1A and 1B, the hand of the user in a VR system is illustrated in different frames in FIGS. 1A and 1B. The positions of reference points 102A and 104A in the frame of FIG. 1A and the positions of reference points 102B and 104B in the frame of FIG. 1B may differ.

As shown, the hand of a user is unable to maintain stability when seen with respect to reference points 102A and 104A in FIG. 1A and reference points 102B and 104B. This instability often occurs due to difficulties in maintaining a consistent reference point for hand tracking, particularly around the wrist area where visual landmarks can be less distinct and subject to occlusion or lighting variations.

Traditional approaches to mitigate tracking instability have employed various filtering techniques, such as Kalman filters and 1Euro filters. While these methods can reduce visible jitter, they typically introduce a trade-off between stability and responsiveness. Specifically, stronger filtering to reduce jitter often results in noticeable latency between the user's physical movements and their virtual representation.

The presence of tracking instability and latency can significantly compromise the quality of user experience in AR/VR applications. Therefore, there exists a need for improved systems and methods for hand tracking that can maintain stable tracking without compromising performance.

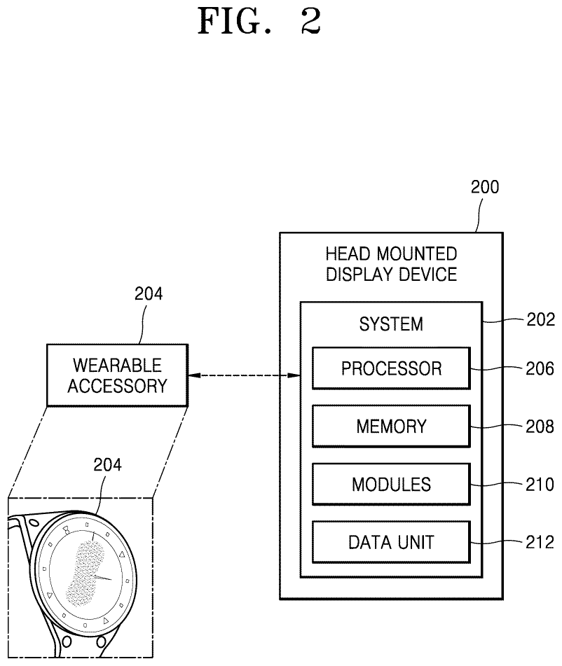

FIG. 2 is a block diagram illustrating an example configuration of a system 202 for hand tracking using a wearable accessory 204, according to various embodiments.

In an embodiment, the system 202 for hand tracking using the wearable accessory 204 may be implemented on a head-mounted display (HMD) device 200. Examples of HMD device 200 may include, but are not limited to, an extended reality (XR) device (such as a virtual reality (VR) headset, an augmented reality (AR) headset, or a mixed reality (MR) headset), a video see-through (VST) device, a smart glass device, or any other wearable display device capable of hand-tracking movements. In an embodiment, the wearable accessory 204 may be a wristwatch, smart band, smart watch, fitness tracker, bracelet, wristband with markers, ring, smart ring, glove with markers, wristlet, or any wearable device that can be secured to a user's hand or wrist region.

The system 202 may include a memory 208, one or more processors (e.g., including processing circuitry) 206 (hereafter referred to as the processor 206), one or more modules (e.g., including various circuitry and/or executable program instructions) 210, and a data unit (e.g., including a memory) 212.

In an example embodiment, the processor 206 may be operatively coupled to each of the memory 208, and the modules 210. In an embodiment, the processor 206 may include at least one data processor for executing processes in Virtual Storage Area Network. The processor 206 may include specialized processing units such as, integrated system (bus) controllers, memory management control units, floating point units, graphics processing units, digital signal processing units, etc. In an embodiment, the processor 206 may include a Central Processing Unit (CPU), a Graphics Processing Unit (GPU), or both. The processor 206 may be one or more general processors, Digital Signal Processors (DSPs), application-specific integrated circuits, Field-Programmable Gate Arrays (FPGAs), servers, networks, digital circuits, analog circuits, combinations thereof, or other now known or later developed devices for analyzing and processing data. The processor 206 may execute a software program, such as code generated manually (e.g., programmed) to perform the desired operation. The processor 206 may implement various techniques such as, but not limited to, image processing, data extraction, Artificial Intelligence (AI), Machine Learning (ML), Deep Learning (DL) and so forth to achieve the desired objective.

In various embodiments, the memory 208 may be communicatively coupled to the at least one processor 206. The memory 208 may be configured to store data, instructions executable by the at least one processor 206. In an embodiment, the memory 208 may communicate via a bus within the system 200. The memory 208 may include, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In an example, the memory 208 may include a cache or random-access memory for the processor 206.

A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

In alternative examples, the memory 208 is separate from the processor 206, such as a cache memory of a processor, the system memory, or other memory. The memory 208 may be an external storage device or database for storing data. The memory 208 may be operable to store instructions executable by the processor 206. The functions, acts or tasks illustrated in the figures or described may be performed by the programmed processor 206 for executing the instructions stored in the memory 208. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing, and the like. The memory 208 may further include a database to store the data. Further, the memory 208 may include an operating system for performing one or more tasks of the system 200, as performed by a generic operating system in the communications domain.

The modules 210, amongst other things, include routines, programs, objects, components, data structures, etc., which perform particular tasks or implement data types. The modules 210 may also be implemented as, signal processor(s), state machine(s), logic circuitries, and/or any other device or component that manipulates signals based on operational instructions. Further, the modules 210 may be implemented in hardware, instructions executed by a processing unit, or by a combination thereof. The processing unit can comprise a computer, the processor 206, a state machine, a logic array, or any other suitable devices capable of processing instructions. The processing unit can be a general-purpose processor which executes instructions to cause the general-purpose processor to perform the required tasks, or the processing unit can be dedicated to performing the required functions. In an embodiment of the present disclosure, the modules 210 may be machine-readable instructions (software) which, when executed by a processor/processing unit, perform any of the described functionalities. Further, the data serves, amongst other things, as a repository for storing data processed, received, and generated by one or more of the modules.

In an embodiment, the data unit 212 serves, amongst other things, as a repository for storing data processed, received, and generated by one or more of the modules 210 and may, for example, include a memory.

In an embodiment of the present disclosure, the processor 206 via the modules 210 is configured to execute machine-readable instructions (software) to perform one or more operations of the system 202 within the scope of the present disclosure as described in greater detail below.

At least one of the plurality of modules may be implemented through an AI model. A function associated with AI may be performed through the non-volatile memory, the volatile memory, and the processor.

The processor may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). Thus, each “processor” or “model” herein may include processing circuitry, and/or may include multiple processors. For example, as used herein, including the claims, the term “processor” or “model” may include various processing circuitry, including at least one processor, wherein one or more of at least one processor, individually and/or collectively in a distributed manner, may be configured to perform various functions described herein. As used herein, when “a processor,” “at least one processor,” “a model,” “at least one model,” and “one or more processors” are described as being configured to perform numerous functions, these terms cover situations, for example and without limitation, in which one processor and/or model performs some of recited functions and another processor(s) and/or model(s) performs other of recited functions, and also situations in which a single processor and/or model may perform all recited functions. Additionally, the at least one processor may include a combination of processors performing various of the recited/disclosed functions, e.g., in a distributed manner. At least one processor may execute program instructions to achieve or perform various functions. Likewise, the at least one model may include a combination of circuitry and/or processors performing various of the recited/disclosed functions, e.g., in a distributed manner. At least one processor and/or model may execute program instructions to achieve or perform various functions.

The one or a plurality of processors control the processing of the input data in accordance with a predefined operating rule or artificial intelligence (AI) model stored in the non-volatile memory and the volatile memory. The predefined operating rule or artificial intelligence model is provided through training or learning.

Being provided through learning may refer, for example, to, by applying a learning technique to a plurality of learning data, a predefined operating rule or AI model of a desired characteristic being made. The learning may be performed in a device itself in which AI according to an embodiment is performed, and/or may be implemented through a separate server/system.

The AI model may include of a plurality of neural network layers. Each layer may have a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), deep Q-networks, or the like.

The learning technique may refer, for example a method for training a predetermined target device (for example, a robot) using a plurality of learning data to cause, allow, or control the target device to make a determination or prediction. Examples of learning techniques include, but are not limited to, supervised learning, unsupervised learning, semi-supervised learning, or reinforcement learning.

According to the disclosure, in a method of an electronic device, a method for generating a plurality of instructions for enhancing motor skills of a user may use an artificial intelligence model to recommend/execute the plurality of instructions using sensor data. The processor may perform a pre-processing operation on the data to convert into a form appropriate for use as an input for the artificial intelligence model. The artificial intelligence model may be obtained by training. Here, “obtained by training” may refer, for example, to a predefined operation rule or artificial intelligence model configured to perform a desired feature (or purpose) being obtained by training a basic artificial intelligence model with multiple pieces of training data by a training technique. The artificial intelligence model may include a plurality of neural network layers. Each of the plurality of neural network layers may include a plurality of weight values and performs neural network computation by computation between a result of computation by a previous layer and the plurality of weight values.

Reasoning prediction may refer, for example, to a technique of logically reasoning and predicting by determining information and includes, e.g., knowledge-based reasoning, optimization prediction, preference-based planning, or recommendation

In an embodiment, the system 202 is configured to receive one or more input images of one or more hands of a user. The system 202 is configured to identify at least one wearable accessory (for example, the wearable accessory 204) including a plurality of trackable portions, worn by the user on any one of the one or more hands.

The system 202 is configured to determine a plurality of feature points in the plurality of trackable portions of the wearable accessory 204. The system 202 is configured to track a plurality of key-points of the one or more hands of the user and a plurality of feature points in the trackable portions of the wearable accessory 204. The system 202 is configured to determine a first motion trajectory of the one or more hands using the plurality of key-points of the one or more hands of the user. The system 202 is configured to determine a second motion trajectory of the wearable accessory using the plurality of feature points. The system 202 is configured to correlate the first motion trajectory of the one or more hands of the user with the second motion trajectory of the wearable accessory to estimate hand-trajectory noise model. The system 202 is configured to perform hand tracking of the one or more hands of the user by correcting the corresponding first motion trajectory using the obtained hand-trajectory noise model.

To track the plurality of feature points in the trackable portions of the wearable accessory 204, the system 202 is configured to receive data related to tracked wearable accessory for one or more previous frames as input. The system 202 is configured to determine one or more regions of the wearable accessory to identify the one or more trackable portions. The system 202 is configured to obtain one or more optical flow trajectories of the one or more trackable portions. The system 202 is configured to determine a correlation among the obtained one or more optical flow trajectories. The system 202 is configured to filter the plurality of feature points in the trackable portions of wearable accessory based on correlation of the one or more optical flow trajectories to obtain a refined plurality of feature points. Further, the system 202 is configured to track the plurality of feature points in the trackable portions of the wearable accessory based on the refined plurality of feature points.

In an embodiment, to correct the corresponding first motion trajectory of the one or more hands of the user, the system 202 is configured to receive two or more motion trajectories of the one or more hands of the user and the plurality of feature points in the trackable portions of the wearable accessory. The system 202 is configured to normalize the range of the two or more motion trajectory of the one or more hands of the user and the plurality of feature points in the trackable portions of the wearable accessory 204. The system 202 is configured to estimate, using a motion model, one or more parameters of the normalized two or more motion trajectories and the plurality of feature points in the trackable portions of the wearable accessory, wherein the motion model is polynomial fitting. The system 202 is configured to extract noise in the normalized two or more motion trajectories using the normalized trajectory in the trackable portions of the wearable accessory. The system 202 is configured to estimate one or more parameters of the hand-trajectory noise model using the extracted noise. In an embodiment, the one or more parameters is an additive white Gaussian (AWGN). The system 202 is configured to correct the two or more motion trajectories of the one or more hands of the user using the estimated one or more parameters of the motion model and the one or more parameters of the hand-trajectory noise model. The one or more regions may include glare and corners of the wearable accessory.

The disclosure enables tracking of a point of origin on the wrist and utilizes the visual differentiation identified by the wearable accessory 204. The point of origin may be continuously located on the wrist, therefore minimizing and/or reducing the shift of the point of origin and therefore, correcting jitters in the hand movement.

Data from the jitter pattern being corrected on one hand may be used to predict a jitter pattern in the non-accessory hand. Therefore, the jitter in the non-accessory hand may be corrected using the predicted data.

If the wearable accessory is capable of detecting hand gestures such as a smartwatch, then the data from the HMD and the wearable accessory may be combined to detect complex hand gestures. For example, where simple hand gestures while using a smartwatch are detected, then stereo cameras for accessory hand tracking are disengaged to save the battery life of the HMD.

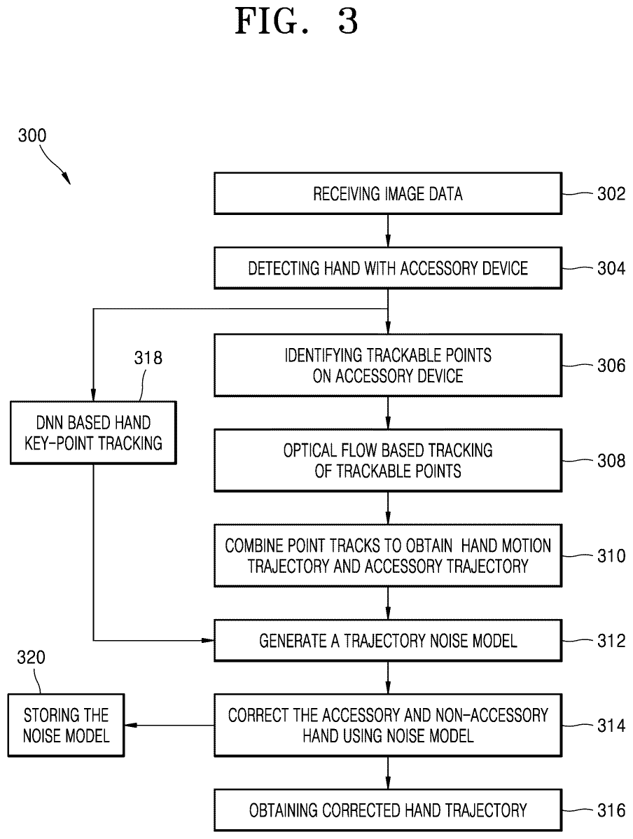

The present disclosure may use optical differentiation of accessory features (e.g., glare and corners) to eliminate inaccurate jitter occurrences during processor overload, dynamic lighting conditions, etc. The present disclosure may utilize the correlation between hand trajectory generated in both the hands to address issues in hand tracking. The system 202 will be described in greater detail below with referenc to FIGS. 3, 4, 5 and 6.

FIG. 3 is a flowchart 300 illustrating example operations of hand tracking using a wearable accessory, according to various embodiments.

At operation 302, the head-mounted display (HMD) device 200 may receive one or more input images of one or more hands of a user. The image images may be captured using one or more cameras integrated within the HMD device. In an embodiment, the input image may include one or more hands of a user wearing the head-mounted display (HMD) device. In an embodiment, the input image may include at least one wearable accessory worn on the user's hand.

At operation 304, the head-mounted display (HMD) device 200 may identify at least one wearable accessory 204 including a plurality of trackable portions, worn by the user on any one of the one or more hands. Thus, the HMD device performs detection of a hand wearing the wearable accessory 204. In scenarios where the HMD device fails to detect a hand with an accessory, such as when the user is not wearing the wearable accessory or when the wearable accessory included in the input image is difficult to identify, the processor is configured to utilize a previously saved hand trajectory noise model for trajectory correction and jitter removal.

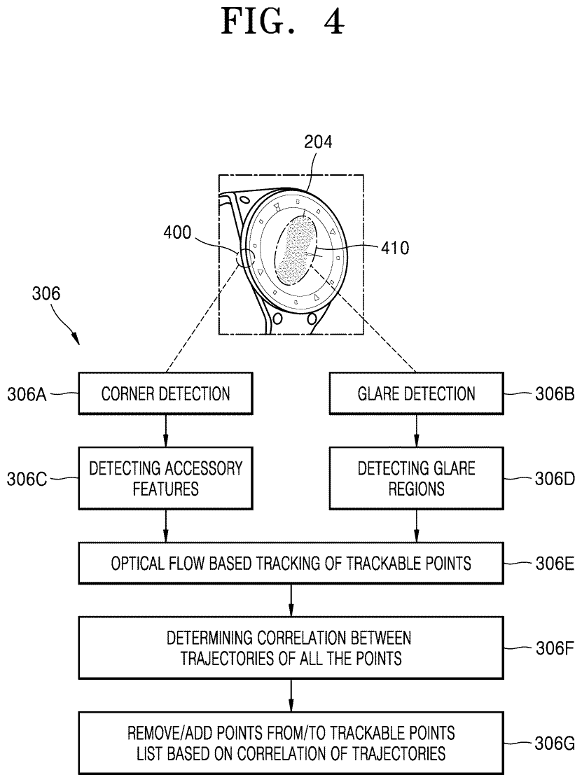

At operation 306, the head-mounted display (HMD) device 200 may determine (or identify) a plurality of feature points in the plurality of trackable portions of the at least one wearable accessory 204. These trackable points comprise distinctive features on the wearable accessory 204 that may be reliably tracked, such as, markings on a watch dial, specific patterns on a wristband, glare region, corner region or other visually distinguishable elements on the wearable accessory 204. The detailed description of operation 306 is provided below with reference to FIG. 4.

At operation 308, the head-mounted display (HMD) device 200 may track a plurality of key-points of the one or more hands of the user and a plurality of feature points in the trackable portions of the wearable accessory 204 respectely. To track the plurality of feature points in the trackable portions of the wearable accessory 204, an optical flow-based tracking mechanism/technique is used to monitor the movement of the identified points across consecutive frames of the image data. The detailed mechanism is described in greater detail below with reference to FIG. 4.

At operation 310, the head-mounted display (HMD) device 200 may determine a first motion trajectory of the one or more hands using the plurality of key-points of the one or more hands of the user. The head-mounted display (HMD) device 200 may determine a second motion trajectory of the wearable accessory 204 using the plurality of feature points. The head-mounted display (HMD) device 200 may correlate the first motion trajectory of the one or more hands of the user with the second motion trajectory of the wearable accessory 204 to estimate hand-trajectory noise model. Since all point tracks represent the movement of the wrist, their combination into a unified track serves to minimize and/or reduce trajectory noise, thereby enhancing tracking accuracy.

Parallel to operations 306-310, the head-mounted display (HMD) device 200 may include performing Deep Neural Network (DNN) on the plurality of trackable portions for the detected hand with the wearable accessory 204 from operation 304 to generate the hand-trajectory noise model at operation 312.

The head-mounted display (HMD) device 200 may correct the corresponding first motion and perform trajectory using the obtained hand-trajectory noise model at operation 312 to perform hand tracking of the one or more hands of the user at operation 314. The hand-trajectory noise model may be derived using the first motion trajectory of the one or more hands using the plurality of key-points of the one or more hands of the user and the second motion trajectory of the wearable accessory 204 using the plurality of feature points, using DNN.

The hand-trajectory noise model becomes particularly valuable in scenarios where the system is unable to detect a hand with a wearable accessory 204 thereby allowing for trajectory correction and jitter removal based on previously learned patterns.

In an embodiment where the HMD device fails to detect a hand with a wearable accessory 204 at operation 304, the system automatically queries the database of saved noise models 320. Upon finding a suitable noise model, the system applies it to correct the trajectory of the hands of the user and mitigate jitter in the hand-tracking data.

At operation 316, the HMD device 200 may obtain corrected hand trajectories corresponding to the accessory-wearing hand and the non-accessory hand by using the noise model.

FIG. 4 is a flowchart illustrating example operations relating to operation 306 of FIG. 3 to identify the trackable portions of the wearable accessory 204, according to various embodiments. The head-mounted display (HMD) device 200 may include implementing a combination of corner detection and glare detection techniques to establish reliable tracking points on the wearable accessory 204.

At operation 306A, the head-mounted display (HMD) device 200 may perform corner detection on the wearable accessory surface. In an embodiment, for the corner detection, the head-mounted display (HMD) device 200 may utilize standard feature detection methods, such as the Shi-Tomasi corner detection, to identify distinct trackable points (such as corner 400) on the wearable accessory 204.

At operation 306B, the head-mounted display (HMD) device 200 may perform glare detection on the wearable accessory surface. This step is particularly significant as most hand accessories comprise shiny or reflective surfaces 410 that generate point-specular reflections. These reflections, when properly identified, serve as additional trackable points.

At operation 306C, the head-mounted display (HMD) device 200 may identify wearable accessory features utilizing the corner detection results from step 306A. At operation 306D, the head-mounted display (HMD) device 200 may detect and isolate specific glare regions based on detected glare.

At operation 306E, the head-mounted display (HMD) device 200 may implement optical flow based tracking of the identified trackable points. This tracking mechanism monitors both the corner-based features and glare-based features identified in operations 306C and 306D.

The head-mounted display (HMD) device 200, at operation 306F, may determine the correlation between the trajectories of all tracked points. This correlation analysis serves to identify which points are moving consistently with the overall wearable accessory movement and which points may represent noise or incorrect tracking.

At operation 306G, the head-mounted display (HMD) device 200 may include a dynamic update of the list of trackable points based on the correlation analysis. For example, the points whose trajectories demonstrate low correlation with the majority of other tracked points are removed from the inlier set. Conversely, new points that become visible and demonstrate a high correlation with existing trajectories may be added to the tracking set.

In an embodiment, the set of inlier points is continuously updated throughout the tracking process. This ensures robust tracking by maintaining a reliable set of trackable points even as lighting conditions change or as the wearable accessory moves through different orientations.

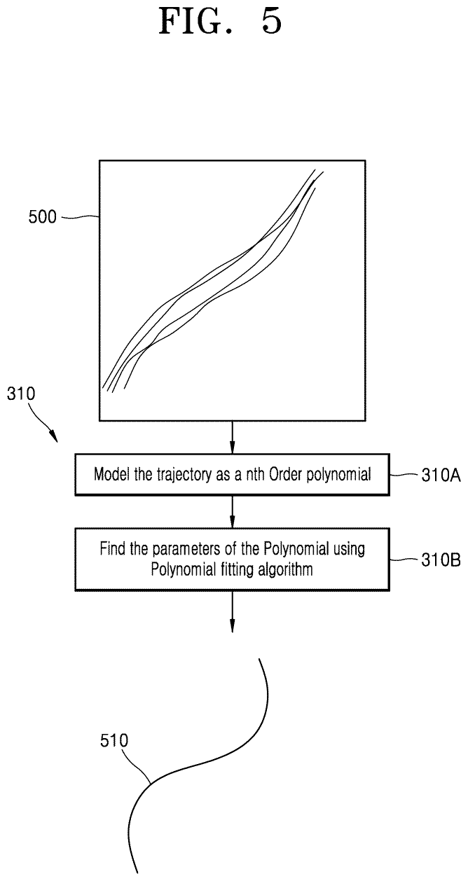

FIG. 5 is a flowchart illustrating example operations relating to operation 310 of FIG. 3 for combining tracking points to obtain an accessory trajectory, according to various embodiments. The head-mounted display (HMD) device 200 may implement a polynomial modelling approach to achieve a smooth and accurate representation of the wearable accessory's movement path.

At operation 310A, the head-mounted display (HMD) device 200 may include modelling an nth-order polynomial based on a plurality of trajectories 500, where n represents the order of the polynomial selected according to the complexity of the movement pattern. In an embodiment, as the complexity of the movement pattern increases, the order of the polynomial to be modeled may also increase

At operation 310B, the head-mounted display (HMD) device 200 may determine the coefficients of the polynomial model using a polynomial fitting method. The fitting method computes the coefficients of the polynomial that best represent the collective movement of all tracked points while minimizing and/or reducing the overall fitting error across the plurality of trajectories. Based on the polynomial model, an optimized trajectory 510 of the accessory may be estimated.

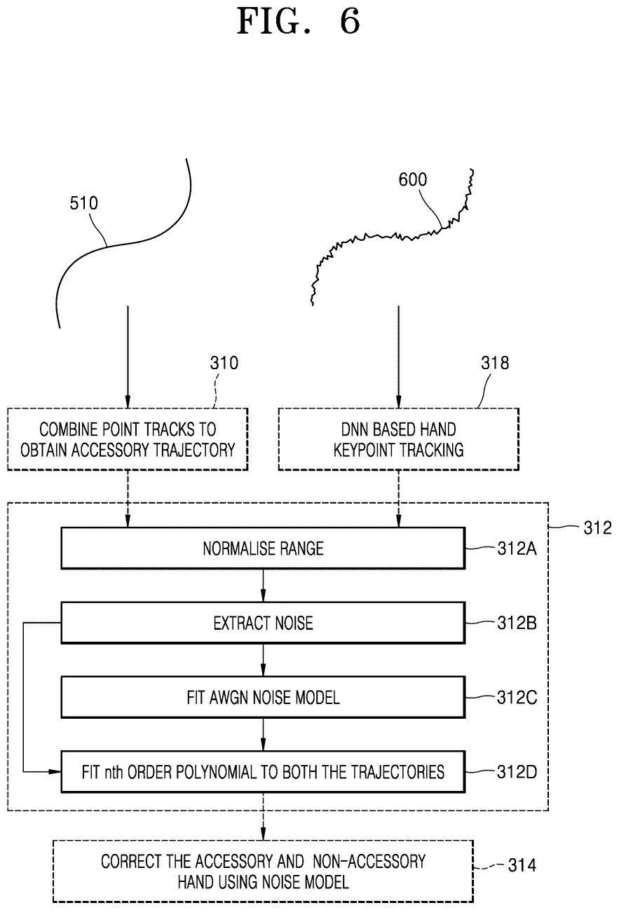

FIG. 6 is a flowchart illustrating example operations for generating a hand-trajectory noise model, according to various embodiments. For generating a hand-trajectory noise model, the head-mounted display (HMD) device 200 may process two trajectories: a first motion trajectory 600 of the one or more hands using the plurality of key-points of the one or more hands of the user, at operation 318 (refer to FIG. 3), and a second motion trajectory 510 of the wearable accessory 204 using the plurality of feature points, at operation 310 (refer, to FIGS. 3 and 5). However, the present disclosure is not limited thereto, and the first motion trajectory 600 may be the one or more first motion trajectories of the user determined at operation 310 (refer to FIG. 3).

At operation 312A, the head-mounted display (HMD) device 200 may perform normalization of both input trajectories. The input trajectories are two or more motion trajectory of the one or more hands of the user and the plurality of feature points in the trackable portions of the wearable accessory 204. The head-mounted display (HMD) device 200 may normalize range of the two or more motion trajectory of the one or more hands of the user and the plurality of feature points in the trackable portions of the wearable accessory 204. The normalization process adjusts the range of trajectory values to ensure consistent processing and comparison.

At operation 312B, the head-mounted display (HMD) device 200 may extract noise patterns by analyzing the normalized trajectories. The head-mounted display (HMD) device 200 may extract noise patterns by using the optimized second motion trajectory as a reference, and calculating the difference between the normalized first motion trajectory and the normalized second motion trajectory.

At step 312C, the head-mounted display (HMD) device 200 may fit an noise model (such as Additive White Gaussian Noise (AWGN) model, Random Walk Noise Model) to the extracted noise patterns. Hereinafter, for convenience of explanation, the noise model will be described as an AWGN model. The AWGN model characterizes the statistical properties of the observed tracking noise, providing a mathematical framework for subsequent correction steps.

At operation 312D, the head-mounted display (HMD) device 200 may fit an nth-order polynomial to both trajectories. In an embodiment, the same polynomial order is utilized for both trajectories, as the overall shape of the movements is fundamentally similar. However, the coefficient values of the polynomials may differ due to slight variations in the tracked directions.

Generating a trajectory noise model may employ a multi-layer perceptron (MLP) neural network to learn a residual correction trajectory. This neural network takes as input the polynomial coefficients from trajectories and the parameters of the AWGN noise model to generate appropriate corrections for the noisy trajectory.

At operation 314, the HMD device 200 may correct the second motion trajectory 510 obtained from the accessory-wearing hand and the first motion trajectory obtained 600 from the non-accessory hand using the noise model.

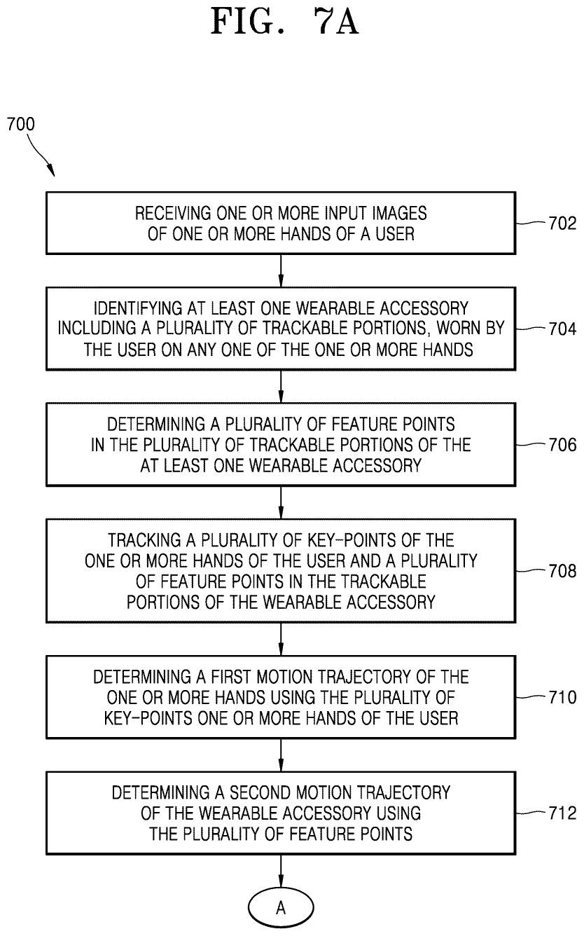

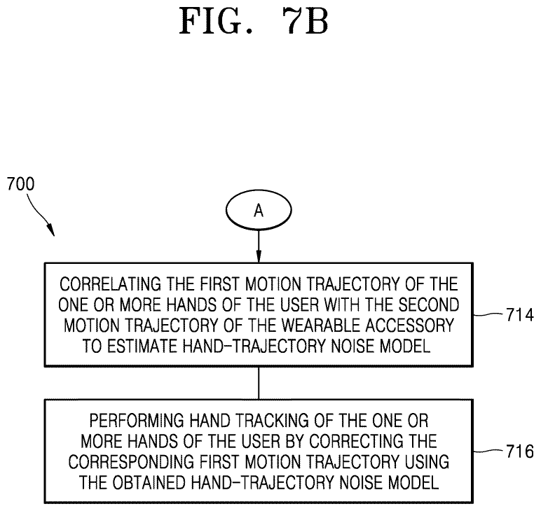

FIG. 7A is a flowchart illustrating an example method for hand tracking using a wearable accessory, according to various embodiments. FIG. 7B is a flowchart illustrating an example method for hand tracking using a wearable accessory, according to various embodiments.

At operation 702, the method 700 comprises receiving one or more input images of one or more hands of a user.

At operation 704, the method 700 comprises identifying at least one wearable accessory including a plurality of trackable portions, worn by the user on any one of the one or more hands. The wearable accessory includes any one of: wristband, watch, bangle, bracelet, thread, and other such wearable items. Further, the trackable portions are easily identifiable features on the accessory.

At operation 706, the method 700 comprises determining a plurality of feature points in the plurality of trackable portions of the at least one wearable accessory.

At operation 708, the method 700 comprises tracking a plurality of key-points of the one or more hands of the user and a plurality of feature points in the trackable portions of the wearable accessory.

At operation 710, the method 700 comprises determining a first motion trajectory of the one or more hands using the plurality of key-points of the one or more hands of the user.

At operation 712, the method 700 comprises determining a second motion trajectory of the wearable accessory using the plurality of feature points.

At operation 714, the method 700 comprises correlating the first motion trajectory of the one or more hands of the user with the second motion trajectory of the wearable accessory to estimate the hand-trajectory noise model.

At operation 716, the method 700 comprises performing hand tracking of the one or more hands of the user by correcting the corresponding first motion trajectory using the obtained hand-trajectory noise model.

In an embodiment, for tracking the plurality of feature points in the trackable portions of the wearable accessory, the method 700 comprises receiving data related to tracked wearable accessory for one or more previous frames as input. The method 700 comprises determining one or more regions of the wearable accessory to identify the one or more trackable portions. The one or more regions include glare and corners of the wearable accessory. The method 700 comprises obtaining one or more optical flow trajectories of the one or more trackable portions. The method 700 comprises determining a correlation among the obtained one or more optical flow trajectories. The method 700 comprises filtering the plurality of feature points in the trackable portions of wearable accessory based on correlation of the one or more optical flow trajectories to obtain a refined plurality of feature points. The method 700 comprises tracking the plurality of feature points in the trackable portions of the wearable accessory based on the refined plurality of feature points.

In an embodiment, for correcting the corresponding first motion trajectory of the one or more hands of the user, the method 700 comprises receiving as input two or more motion trajectory of the one or more hands of the user from the hand-trajectory noise model and the plurality of feature points in the trackable portions of the wearable accessory. The method 700 comprises normalizing range of the two or more motion trajectory of the one or more hands of the user and the plurality of feature points in the trackable portions of the wearable accessory. The method 700 comprises estimating, using a motion model, one or more parameters of the normalized two or more motion trajectory and the plurality of feature points in the trackable portions of the wearable accessory, wherein the motion model is polynomial fitting. The method 700 comprises extracting noise in the normalized two or more motion trajectory using the normalized trajectory in the trackable portions of the wearable accessory. The method 700 comprises estimating one or more parameters of the hand-trajectory noise model using the extracted noise, wherein the one or more parameters is an additive white Gaussian (AWGN). The method 700 comprises correcting the two or more motion trajectory of the one or more hands of the user using the estimated one or more parameters of the motion model and the one or more parameters of the hand-trajectory noise model.

The present disclosure improves user experience in high processing tasks, dynamic lighting as well as other inaccurate jitter inducing scenarios while operating HMD. The present disclosure improves hand tracking stability across multiple scenarios in HMD.

According to an example embodiment of the present disclosure, a method for hand tracking for a Head Mounted Display (HMD) device is disclosed. The method includes obtaining one or more input images of one or more hands of a user. The method includes identifying at least one wearable accessory including a plurality of trackable portions, worn by the user on any one of the one or more hands. The method includes determining a plurality of feature points in the plurality of trackable portions of the at least one wearable accessory. The method includes determining a first motion trajectory of the one or more hands by tracking a plurality of key-points of the one or more hands of the user. The method includes determining a second motion trajectory of the wearable accessory by tracking a plurality of feature points in the trackable portions of the wearable accessory. The method includes generating a hand-trajectory noise model by correlating the first motion trajectory of the one or more hands of the user with the second motion trajectory of the wearable accessory. The method includes performing hand tracking of the one or more hands of the user by correcting the corresponding first motion trajectory using the obtained hand-trajectory noise model.

According to an example embodiment of the present disclosure, wherein the tracking the plurality of feature points in the trackable portions of the wearable accessory includes receiving data related to tracked wearable accessory for one or more previous frames as input. Wherein the tracking the plurality of feature points in the trackable portions of the wearable accessory includes determining one or more regions of the wearable accessory to identify the one or more trackable portions. Wherein the tracking the plurality of feature points in the trackable portions of the wearable accessory includes obtaining one or more optical flow trajectories of the one or more trackable portions.

According to an example embodiment of the present disclosure, the method further include determining a correlation among the obtained one or more optical flow trajectories. The method further include filtering the plurality of feature points in the trackable portions of wearable accessory based on correlation of the one or more optical flow trajectories to obtain a refined plurality of feature points. The method further include tracking the plurality of feature points in the trackable portions of the wearable accessory based on the refined plurality of feature points.

According to an example embodiment of the present disclosure, wherein the correcting the corresponding first motion trajectory of the one or more hands of the user includes obtaining two or more motion trajectory of the one or more hands of the user and the plurality of feature points in the trackable portions of the wearable accessory. Wherein the correcting the corresponding first motion trajectory of the one or more hands of the user includes normalizing range of the two or more motion trajectory of the one or more hands of the user and the plurality of feature points in the trackable portions of the wearable accessory.

According to an example embodiment of the present disclosure, the method further include estimating, using a motion model, one or more parameters of the normalized two or more motion trajectory and the plurality of feature points in the trackable portions of the wearable accessory, wherein the motion model comprises polynomial fitting. The method further include extracting noise in the normalized two or more motion trajectory using the normalized trajectory in the trackable portions of the wearable accessory. The method further include estimating one or more parameters of the hand-trajectory noise model using the extracted noise, wherein the one or more parameters comprises an additive white Gaussian (AWGN). The method further include correcting the two or more motion trajectory of the one or more hands of the user using the estimated one or more parameters of the motion model and the one or more parameters of the hand-trajectory noise model.

According to an example embodiment of the present disclosure, wherein the one or more regions include glare and corners of the wearable accessory.

According to an example embodiment of the present disclosure, wherein the wearable accessory includes any of a: wristband, watch, bangle, bracelet, thread, and a wearable.

According to an example embodiment of the present disclosure, wherein the trackable portions are easily identifiable features on the accessory.

According to an example embodiment of the present disclosure, a system for hand tracking for a Head Mounted Display (HMD) device is disclosed. The system includes a memory storing at least one instruction. The system includes at least one processor, comprising a processing circuitry. Wherein the at least one processor is configured to individually or collectively execute the at least one instruction stored in the memory to: obtain one or more input images of one or more hands of a user and identify at least one wearable accessory including a plurality of trackable portions, worn by the user on any one of the one or more hands. Wherein the at least one processor is configured to individually or collectively execute the at least one instruction stored in the memory to: determine a plurality of feature points in the plurality of trackable portions of the at least one wearable accessory. Wherein the at least one processor is configured to individually or collectively execute the at least one instruction stored in the memory to: determine a first motion trajectory of the one or more hands by tracking a plurality of key points of the one or more hands of the user. Wherein the at least one processor is configured to individually or collectively execute the at least one instruction stored in the memory to: determine a second motion trajectory of the wearable accessory by tracking a plurality of feature points in the trackable portions of the wearable accessory. Wherein the at least one processor is configured to individually or collectively execute the at least one instruction stored in the memory to generate a hand-trajectory noise model by correlating the first motion trajectory of the one or more hands of the user with the second motion trajectory of the wearable accessory. Wherein the at least one processor is configured to individually or collectively execute the at least one instruction stored in the memory to: perform hand tracking of the one or more hands of the user by correcting the corresponding first motion trajectory using the obtained hand-trajectory noise model.

According to an example embodiment of the present disclosure, wherein to track the plurality of feature points in the trackable portions of the wearable accessory, at least one processor is configured to individually or collectively execute the at least one instruction stored in the memory to: receive data related to tracked wearable accessory for one or more previous frames as input. Wherein the at least one processor is configured to individually or collectively execute the at least one instruction stored in the memory to: determine one or more regions of the wearable accessory to identify the one or more trackable portions. Wherein the at least one processor is configured to individually or collectively execute the at least one instruction stored in the memory to: obtain one or more optical flow trajectories of the one or more trackable portions.

According to an example embodiment of the present disclosure, wherein at least one processor is configured to individually or collectively execute the at least one instruction stored in the memory to: determine a correlation among the obtained one or more optical flow trajectories. Wherein at least one processor is configured to individually or collectively execute the at least one instruction stored in the memory to: filter the plurality of feature points in the trackable portions of wearable accessory based on correlation of the one or more optical flow trajectories to obtain a refined plurality of feature points. Wherein at least one processor is configured to individually or collectively execute the at least one instruction stored in the memory to: track the plurality of feature points in the trackable portions of the wearable accessory based on the refined plurality of feature points.

According to an example embodiment of the present disclosure, wherein to correct the corresponding first motion trajectory of the one or more hands of the user, at least one processor is configured to individually or collectively execute the at least one instruction stored in the memory to: obtain two or more motion trajectory of the one or more hands of the user and the plurality of feature points in the trackable portions of the wearable accessory. Wherein the at least one processor is configured to individually or collectively execute the at least one instruction stored in the memory to: normalie range of the two or more motion trajectory of the one or more hands of the user and the plurality of feature points in the trackable portions of the wearable accessory. Wherein the at least one processor is configured to individually or collectively execute the at least one instruction stored in the memory to: estimate, using a motion model, one or more parameters of the normalized two or more motion trajectory and the plurality of feature points in the trackable portions of the wearable accessory, wherein the motion model includes polynomial fitting. Wherein the at least one processor is configured to individually or collectively execute the at least one instruction stored in the memory to: extract noise in the normalized two or more motion trajectory using the normalized trajectory in the trackable portions of the wearable accessory. Wherein the at least one processor is configured to individually or collectively execute the at least one instruction stored in the memory to: estimate one or more parameters of the hand-trajectory noise model using the extracted noise, wherein the one or more parameters includes an additive white Gaussian (AWGN). Wherein the at least one processor is configured to individually or collectively execute the at least one instruction stored in the memory to: correct the two or more motion trajectory of the one or more hands of the user using the estimated one or more parameters of the motion model and the one or more parameters of the hand-trajectory noise model.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method for hand tracking for a Head Mounted Display (HMD) device, the method comprising:
obtaining one or more input images of one or more hands of a user;
identifying at least one wearable accessory including a plurality of trackable portions, worn by the user on any one of the one or more hands;
determining a plurality of feature points in the plurality of trackable portions of the at least one wearable accessory;
determining a first motion trajectory of the one or more hands by tracking a plurality of key-points of the one or more hands of the user;
determining a second motion trajectory of the wearable accessory by tracking a plurality of feature points in the trackable portions of the wearable accessory;
generating a hand-trajectory noise model by correlating the first motion trajectory of the one or more hands of the user with the second motion trajectory of the wearable accessory; and
performing hand tracking of the one or more hands of the user by correcting the corresponding first motion trajectory using the obtained hand-trajectory noise model.

2. The method as claimed in claim 1, wherein tracking the plurality of feature points in the trackable portions of the wearable accessory comprises;
receiving data related to tracked wearable accessory for one or more previous frames as input;
determining one or more regions of the wearable accessory to identify the one or more trackable portions; and
obtaining one or more optical flow trajectories of the one or more trackable portions.

3. The method as claimed in claim 2, further comprising:
determining a correlation among the obtained one or more optical flow trajectories;
filtering the plurality of feature points in the trackable portions of wearable accessory based on correlation of the one or more optical flow trajectories to obtain a refined plurality of feature points; and
tracking the plurality of feature points in the trackable portions of the wearable accessory based on the refined plurality of feature points.

4. The method as claimed in claim 1, wherein correcting the corresponding first motion trajectory of the one or more hands of the user, comprising:
obtaining two or more motion trajectory of the one or more hands of the user and the plurality of feature points in the trackable portions of the wearable accessory; and
normalizing range of the two or more motion trajectory of the one or more hands of the user and the plurality of feature points in the trackable portions of the wearable accessory.

5. The method as claimed in claim 4, further comprising:
estimating, using a motion model, one or more parameters of the normalized two or more motion trajectory and the plurality of feature points in the trackable portions of the wearable accessory, wherein the motion model comprises polynomial fitting;
extracting noise in the normalized two or more motion trajectory using the normalized trajectory in the trackable portions of the wearable accessory;
estimating one or more parameters of the hand-trajectory noise model using the extracted noise, wherein the one or more parameters comprises an additive white Gaussian (AWGN); and
correcting the two or more motion trajectory of the one or more hands of the user using the estimated one or more parameters of the motion model and the one or more parameters of the hand-trajectory noise model.

6. The method as claimed in claim 2, wherein the one or more regions include glare and corners of the wearable accessory.

7. The method as claimed in claim 1, wherein the wearable accessory includes any of a: wristband, watch, bangle, bracelet, thread, and a wearable.

8. The method as claimed in claim 1, wherein the trackable portions are easily identifiable features on the accessory.

9. A system for hand tracking for a Head Mounted Display (HMD) device, the system comprising:
a memory storing at least one instruction; and
at least one processor, comprising a processing circuitry;
wherein the at least one processor is configured to individually or collectively execute the at least one instruction stored in the memory to:
obtain one or more input images of one or more hands of a user;
identify at least one wearable accessory including a plurality of trackable portions, worn by the user on any one of the one or more hands;
determine a plurality of feature points in the plurality of trackable portions of the at least one wearable accessory;
determine a first motion trajectory of the one or more hands by tracking a plurality of key points of the one or more hands of the user;
determine a second motion trajectory of the wearable accessory by tracking a plurality of feature points in the trackable portions of the wearable accessory; and
generate a hand-trajectory noise model by correlating the first motion trajectory of the one or more hands of the user with the second motion trajectory of the wearable accessory; and
perform hand tracking of the one or more hands of the user by correcting the corresponding first motion trajectory using the obtained hand-trajectory noise model.

10. The system as claimed in claim 9, wherein to track the plurality of feature points in the trackable portions of the wearable accessory, at least one processor, individually or collectively, is configured to:
receive data related to tracked wearable accessory for one or more previous frames as input;
determine one or more regions of the wearable accessory to identify the one or more trackable portions; and
obtain one or more optical flow trajectories of the one or more trackable portions.

11. The system as claimed in claim 10, wherein at least one processor, individually or collectively, is configured to:
determine a correlation among the obtained one or more optical flow trajectories;
filter the plurality of feature points in the trackable portions of wearable accessory based on correlation of the one or more optical flow trajectories to obtain a refined plurality of feature points; and
track the plurality of feature points in the trackable portions of the wearable accessory based on the refined plurality of feature points.

12. The system as claimed in claim 9, wherein to correct the corresponding first motion trajectory of the one or more hands of the user, at least one processor, individually or collectively, is configured to:
obtain two or more motion trajectory of the one or more hands of the user and the plurality of feature points in the trackable portions of the wearable accessory;
normalize range of the two or more motion trajectory of the one or more hands of the user and the plurality of feature points in the trackable portions of the wearable accessory.

13. The system as claimed in claim 12, wherein at least one processor, individually and/or collectively, is configured to:
estimate, using a motion model, one or more parameters of the normalized two or more motion trajectory and the plurality of feature points in the trackable portions of the wearable accessory, wherein the motion model includes polynomial fitting;
extract noise in the normalized two or more motion trajectory using the normalized trajectory in the trackable portions of the wearable accessory;
estimate one or more parameters of the hand-trajectory noise model using the extracted noise, wherein the one or more parameters includes an additive white Gaussian (AWGN); and
correct the two or more motion trajectory of the one or more hands of the user using the estimated one or more parameters of the motion model and the one or more parameters of the hand-trajectory noise model.

14. The system as claimed in claim 10, wherein the one or more regions include glare and corners of the wearable accessory.

15. The system as claimed in claim 9, wherein the wearable accessory includes any of a: wristband, watch, bangle, bracelet, thread, and a wearable.

16. The system as claimed in claim 9, wherein the trackable portions are easily identifiable features on the wearable accessory.

17. A non-transitory computer-readable medium having recorded thereon a program, which when executed by at least one processor, causes a system to perform a method of claim 1.
